(19) United States
(12) Patent Application Publication
(10) Pub. No.: US 2024/0145810 A1
(43) Pub. Date: May 2, 2024

(54) BATTERY ARRANGEMENT

(71) Applicant: ZEVX Inc., Gilbert, AZ (US)

(72) Inventors: Charlie Maury, Mesa, AZ (US); Damon Kuhn, Needville, TX (US); James Maury, Mesa, AZ (US); Arunachala Kannan, Gilbert, AZ (US); Ashwin Chandwani, Tempe, AZ (US)

(21) Appl. No.: 18/383,505

(22) Filed: Oct. 25, 2023

Related U.S. Application Data
(60) Provisional application No. 63/475,250, filed on Oct. 26, 2022.

(51) Int. Cl. H01M 10/625; H01M 10/613; H01M 10/6556; H01M 10/6569

(52) U.S. Cl. CPC H01M 10/625; H01M 10/613; H01M 10/6556; H01M 10/6569; H01M 2220/20

(57) ABSTRACT

A modular battery system for an electric vehicle is disclosed. The modular battery system includes a base battery module installed in a motor vehicle at a designated battery tray location and a second battery module installed in said motor vehicle at a second location remote from the designated battery tray location. The base battery module and the second battery module share a single battery cooling system.

### CROSS-REFERENCE TO RELATED APPLICATION

This application claims the benefit of and priority to U.S. Provisional Patent Application Ser. No. 63/475,250, filed on Oct. 26, 2022, the contents of which are hereby incorporated by reference in its entirety.

### TECHNICAL FIELD

The present disclosure relates to a battery arrangement, in particular for electric vehicles, and more particularly to a multilevel battery arrangement (e.g., a three-dimensional array of battery cells).

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

There is an ever-growing demand for battery capacity in electric vehicles. This need is being addressed in significant part through development of batteries having higher and higher energy density. As these new battery technologies have been developed, a need to manage the thermal behaviors of the batteries has grown. The Lithium Ion batteries being widely employed in motor vehicles have a tendency to generate a lot of heat when the batteries are either rapidly charged or rapidly discharged. As a result, battery monitoring systems and battery control systems are widely employed to identify the onset of temperature increases and upon detection of rising temperatures, limitations on battery currents are imposed. Introduction of these restrictions necessarily reduces the efficient utilization of the battery's output for operation of the vehicle. When restrictions on power utilization are imposed, vehicle performance suffers.

The primary approach to managing battery use during operation of an electric vehicle involved a heat exchange system, either by circulating air around the batteries or by circulating a cooled fluid. These work up to a limit but involve the use of vehicle power for circulation of the coolant. Also, these approaches generally involve the provision of spaced between battery cells and battery modules, in each case to permit circulation of some cooling medium around the batteries.

The need for this space has led to adoption of battery arrangements calling for the batteries to be laid out in a grid so that coolant can be circulated through the grid. The typical approach to battery layout in purpose-made electric vehicles is known as the skateboard approach. All the batteries are laid out on a single flat panel along the underside of the vehicle.

It is desirable to provide a battery thermal management approach that does not call for the use of on-board energy supplies for cooling the batteries and that does not suffer from the limitations associated with laying out the batteries in an extensive grid.

### SUMMARY

One aspect of the electric vehicle market involves conversion of internal combustion engine (ICE) vehicles to electric drive vehicles. The conversion of ICE vehicles to full electric involves removing the existing engine/transmission and adding an electric drive train and batteries. Also, the conversion calls for removal of the fuel tanks. When fuel tanks are remote from the engine (often done for safety in ICE vehicles) the space freed up by tank removal becomes available in the electric vehicle. However, it is desirable that the batteries are close to the electric drive equipment to avoid extra weight and cost of long wires. Thus, there is a disconnect in the space available, and the space desired—particularly in the front portion of the vehicle. It is particularly desirable for vehicles that will be hauling significant loads to have as much of the drivetrain weight as far forward as possible. Thus, there is a desire to locate the batteries in a forward location rather than under the floor. However, due to the aforementioned thermal considerations, it has been considered necessary to keep the batteries laid out in a one level grid. Applicants have developed an approach that goes against the accepted belief that a multi-level battery configuration poses too much risk of battery overheating.

According to an aspect, there is provided a multilevel battery configuration made possible through use of battery trays having a cooling plate beneath the batteries for conduction of heat from the batteries. This has been found effective for battery modules as well as for individual battery cells.

According to another aspect, there is disclosed a modular battery system for an electric vehicle. The modular battery system includes a base battery module installed in a motor vehicle at a designated battery tray location and a second battery module installed in said motor vehicle at a second location remote from the designated battery tray location. The base battery module and the second battery module share a single battery cooling system. Pursuant to an implementation, the battery cooling system includes at least one cooling tube that connects the base battery module and the second battery module.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

While the claims are not limited to a specific illustration, an appreciation of the various aspects is best gained through a discussion of various examples thereof. Although the drawings represent illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows.

FIG. 1A illustrates a battery module comprising a multilevel battery arrangement (e.g., a three-dimensional array of battery cells) in accordance with an example;

FIG. 1B illustrates a battery module as in FIG. 1A with interstices between individual battery cells filled with one or more phase-change-materials (PCM);

FIG. 1C illustrates a schematic cross-section view of the battery module of FIG. 1A;

FIG. 2 illustrates a battery module according to another aspect of the present disclosure;

FIGS. 3A and 3B illustrate a base pack and a plurality of minipacks according to an aspect of the disclosure; and

FIG. 4 illustrates a schematic illustration of an embodiment of the battery pack according to an aspect of the disclosure; and

FIG. 5 illustrates a conventional battery module having a plurality of battery packs.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they do not limit the present disclosure to these embodiments and/or examples. On the contrary, the present disclosure covers alternatives, modifications, and equivalents.

Referring now to the drawings, a battery arrangement is disclosed.

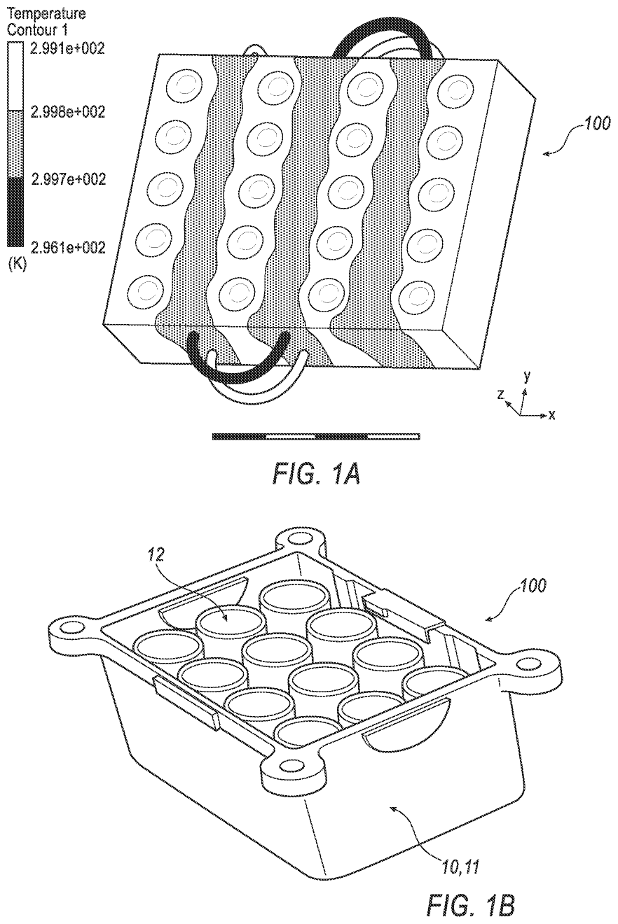

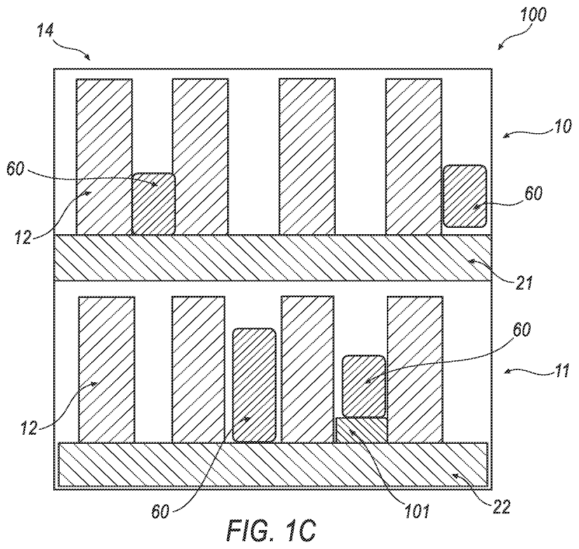

Referring to FIGS. 1A-1C, there is shown a battery arrangement or module 100 comprising a top tray 10 including a plurality of battery cells 12 and a cooling plate 21 along the bottom of the tray 10. Top tray 10 includes a cover 14 to close an interior of the tray. Similarly, bottom tray 11 includes cooling plate 22 along the bottom of the tray 10. The bottom tray 11 may include a cover, or the bottom of top tray 10 may define a cover for the bottom tray 11. The cooling plate(s) 21, 22 includes channels through which a liquid or gaseous medium flows for absorbing and channeling away heat from the cooling plate. Heat from the batteries 12 heats the cooling plate 21, 22 and the cooling medium conducts the heat away. A pump or fan (not shown) circulates the coolant through a piping system (not shown) such that a continuous flow of coolant is provided for extraction of heat from the battery tray.

This has been found suitable for ordinary duty vehicle use, but extreme driving conditions can sometimes exceed the design capacity of the cooling system. Of course, larger and larger cooling systems could be employed, but this is not feasible for a commercial product. Ultimately, the system needs to be designed so it closely matches the requirements but doesn't take over the entirety of the system.

As mentioned, one known limitation in the use of lithium ion batteries is their tendency to overheat during rapid charging or rapid discharging. Overheating was initially a fire risk, but with newer technologies, the overheating risk is now mostly associated with reductions in the service lifetime of a lithium ion battery. A characteristic of lithium ion batteries is that they have internal electrical resistance that contributes to heat generation when high currents are present. Speedy recharging necessarily requires introduction of high amounts of energy within a short period of time—a requirement that corresponds to high charge currents. This is somewhat offset by the trend toward higher battery voltage, but there is no escaping the correlation between charge current and the introduction of energy—higher energy input at any given voltage corresponds to a higher charge current. This in turn correlates with higher heat generation within the battery. Management of the battery charging systems has been an area of extensive development over the past few years, with efforts directed to monitoring of the battery state of charge, monitoring the battery temperature, and regulating the charge current to keep the temperature below temperatures that are damaging to the battery or that are prone to overheating of anything that is adjacent the battery.

Managing the thermal performance of batteries within the vehicle is a multi-faceted undertaking, requiring not only the assessment of the amount of heat being generated, but also the spatial considerations associated with managing the heat energy. A desirable design of motor vehicles calls for placement of the batteries in a location where they do not interfere with the utility of the vehicle. One known and reasonably successful design is widely referred to as the ‘skateboard’ design, a design having a battery tray located along a lower portion of the vehicle structure, below the passenger cabin in a passenger vehicle. The batteries are located in this tray in a closely spaced configuration. For other vehicles, batteries can be located where convenient, but in most instances the batteries are grouped together in one or more battery compartments. For instance, in an electric over the road commercial truck, batteries can be placed beneath the driver's compartment, or even forward of the driver's compartment such that the weight of the batteries is carried relatively far forward in the vehicle. In any event, the batteries are grouped closely together in one or more battery compartments. The close spacing of the batteries has an undesirable consequence in terms of the thermal management of the batteries. Dissipation of the heat generated during rapid charging of the batteries becomes complicated when the battery cells are closely packed due to a lack of free air flow around the individual battery cells. To address the heating of the batteries, the thermal management systems described above with respect to FIG. 1 are employed, with a consequence of reducing the amount of heating of the batteries. This heating generally results in reducing the rate of battery charging and thus extends the time needed for a thorough battery charge cycle. Some efforts to manage the excessive heat involve circulating lots of air through the battery storage compartments, even including heat exchangers for increasing the amount of heat that can be absorbed from the batteries and expelled outside of the vehicle. These approaches have involved simple airflow designs as well as liquid cooling designs with a remotely-located liquid-to-air heat exchanger. All of these systems rely on the batteries getting hot first, and then collecting the excess heat for discharge of the excess heat energy somewhere away from the batteries. As a result of the initial heating of the batteries, before significant heat dissipation commences, there is still a need for regulating the rate at which the batteries can be charged, and thus limiting the rate of charge to a rate that is below the optimum rate.

It would be desirable to have the batteries charged at a faster rate rather than at the reduced rate necessitated by existing thermal management approaches. Another aspect of the present invention addresses this commercial need by providing a quantity of phase change material in thermal communication with the batteries to increase the amount of heat that the battery can dissipate before the temperature starts to rise.

There are many examples of the use of phase-change-materials (PCM) for cooling purposes. For instance, putting ice in a glass of water is a well-known technique for keeping the water cool as it is being consumed. The thermal energy needed to melt the ice is extracted from the water, keeping the water cool as the ice melts. According to the present invention, PCMs can be used to assist in the thermal management of batteries for electric vehicles during a battery charging cycle. This approach allows a relatively small mass of PCM to be used to extract significant energy from the batteries as they are being charged, and it works much more quickly and efficiently than is generally feasible when relying on an approach based (directly or indirectly) on air cooling.

The potential use of PCM materials for extracting energy from batteries in an electric vehicle was mentioned in an article entitled “Recent Developments in Phase Change Materials for Energy Storage Applications: A Review” by Hassan Nazir, Mariah Batool, Francisco J. Bolivar Osorio, Marllory Isaza-Ruiz, Xinhai Xu, K. Vignarooban, Patrick Phelan, Inamuddin, and Arunachala M. Kannan, (particularly including a segment on page 503 thereof) published in the INTERNATIONAL JOURNAL OF HEAT AND MASS TRANSFER 129 (2019). This article is hereby incorporated by reference in its entirety. While the article mentioned the use of PCM for lithium ion batteries, it specifically mentioned that these applications require further research. The present invention is based on such further research and related development efforts resulting in a battery thermal management system and method that meet the expectations of automotive consumers.

The provision of a layer of PCM 60, or a body of PCM, in thermally conductive contact with a battery cell 12, such as by surrounding the battery cell (fully or partially) with a PCM layer or immersing the battery cell in a body of PCM, provides a structure compatible with having the PCM absorb heat energy from the battery when the battery temperature rises above the temperature of the PCM. By selecting a PCM with a phase change point that is below the temperature at which battery degradation is significant, and preferably below the upper range of efficient operation of the battery cell, the temperature of the PCM will remain fairly constant as the material transitions from one phase to the next, either from a solid to a liquid or as the PCM evaporates, as the case may be, resulting in an extended period of time during which heat energy can be readily absorbed by the PCM. According to a preferred implementation of the invention, by selecting a PCM with sufficient specific heat capacity, a suitable latent heat of fusion and an appropriate melting/freezing temperature it is possible to fashion a system that can meet commercial and consumer demands. Thus, for an electric vehicle that is intended to be charged and discharged many times over the lifetime of the vehicle, the present invention provides a thermal management solution that protects the battery cells from thermally induced degradation.

While the description of the invention provided herein is mostly directed to thermal management during rapid battery charging, it is to be understood that similar considerations come into play during periods of high power output from the batteries. The invention is also well suited for thermal management of batteries during these periods of high power output.

Referring to FIGS. 1A-1C, a battery module 100 is illustrated having three rows of two battery cells 12. Each cell is a generally cylindrical Lithium-Ion battery cell, and the cells are arranged in close proximity to each other in order to achieve a tight packing density of the cells 12. This provides a battery module with significant energy density. A phase change material (PCM) 60 is provided along the length of each row of cells and is in thermal communication with the exterior surface of each battery cell. A PCM confinement chamber (battery trays 10 and 11 in this embodiment) holds the PCM adjacent the exterior walls of the battery cells. Flow paths containing cooling fluid are provided in thermal communication with the floor, and potentially also the walls of trays 10, 11 for thermal conduction. It could also be structured so that the PCM is adjacent the cells and a coolant flows adjacent the surface of the PCM (as defined by the outer walls of the PCM confinement chambers) between adjacent rows of cells to accommodate cooling fluid flow in a flow direction along the length of each row of cells. An alternate flow direction for the cooling fluid (not separately shown) would allow fluid flow perpendicular to the rows of cells, providing a more consistent fluid temperature to be maintained across all cells due to the fluid not necessarily passing a plurality of previous cells before reaching later cells in the fluid flow path.

A thermoelectric generator TEG 101 is shown in thermal communication with the PCM in the vicinity one of the cells. This results in indirect thermal communication of the TEG to the battery cell 12. In practice, the TEG 101 would be exposed to the cooling fluid on one side and to the PCM on the other side in a manner that would initiate power generation whenever the PCM temperature differs from the temperature of the cooling fluid. As many TEG units could be provided as will efficiently fit within the structure, even potentially having more than one TEG for each battery cell. Alternatively, a TEG 101 might be placed between two adjacent battery cells and extend into the fluid flow path for the cooling fluid. This might allow for increased surface exposure of the TEG to the PCM material for maximum thermal transfer into the TEG from the PCM.

In an alternative implementation of the invention, the cooling fluid could be omitted and the interstices between the cells could be filled with PCM 60, as illustrated. This would have the advantage of providing more PCM within the given volume of the battery module, but with the consequence of eliminating one mechanism for discharging heat from the overall unit that can be achieved by having a flowing medium pass between the cells. Thus, if the PCM cannot absorb all of the heat generated by the battery cells, temperature escalation might not be as effectively mitigated. Thus, provision of the cold plate at the bottom of the trays is preferred.

Although cylindrical cells are illustrated, there could be other workable shapes for the battery cells, such as hexagons or other polygons. A preferred characteristic of the cells is that there is some space between the cells within the module to permit a layer of PCM to surround and to be in thermal communication with each cell. While surrounding the cells with PCM is preferred, it will be appreciated that any amount of PCM in thermal communication with a cell will contribute to the passage of heat energy between the cell and the PCM. Historically, air, as a cooling medium, was passed between the Lithium-ion cells for cooling of the cells. Liquid has also been used for cooling of battery cells and can be circulated to a remote (not shown) liquid to air heat exchanger for discharging excess heat.

Use of PCM in contact with (or at least in thermal communication with) the cells can provide quicker heat absorption relative to passing a fluid across the outer surface of the cells because the PCM maintains a consistent temperature and thus a steady heat transfer capability between the cell and the PCM as the phase change is underway. Structures relying on fluid flow suffer from the fluid taking on a gradually rising temperature as the cooling process advances, resulting in a declining efficiency of heat transfer from the battery cells. Thermal communication, in this context, refers to allowing thermal energy to pass from one material to another, either via direct physical contact, or by passing through one or more physical barriers, such as the container or confining walls for containment of one or more of the materials. The important consideration is that the thermal energy can get from the first material to the other material.) For the duration of the energy absorption necessary to complete the phase change within the PCM, the temperature of the PCM is substantially constant—right at the phase change temperature. Thus, the outside walls of the cells are maintained at a relatively stable temperature. When the cooling fluid approach is used without PCM, the walls of the cell rise in temperature because of the rise in temperature of the cooling fluid. In the case of air cooling, there is a considerable temperature difference between the air and the surface that is transferring heat energy into the air. This temperature-stabilizing feature of the PCM provides for improved control of the temperature of the cell over a significantly longer period of time (over such time as is necessary for removal of the thermal energy needed to achieve a complete phase change within the PCM) than was achievable using the fluid coolant approach.

In a preferred implementation of the invention, the thermal absorption capacity of the PCM located adjacent each battery cell is sufficient to absorb a quantity of energy (heat energy) to safeguard the cells. In practice, each cell will be operating in a known environment where its charging and discharging behavior will be controlled by battery control equipment. Such equipment is well known for previous Lithium ion battery applications and such control equipment will be equally suitable for use in accordance with the invention. However, in accordance with the invention the battery will have the incremental protections provided by the PCM.

In one implementation of the invention, a layer of PCM having a thickness of between about 3 mm and about 5 mm is applied to the outer surface of each battery cell. The PCM will also be contiguous from cell to cell along the length of each row of cells, providing good thermal communication form cell to cell along the length of each row of cells. This will provide for uniform phase change behavior for the PCM adjacent all cells in each row and will thus result in a uniform thermal environment for the cells in each row.

Providing a cooling fluid flow path between adjacent rows of cells as shown in FIG. 1A will provide a mechanism for discharge of excess heat energy from the battery module. This will be operative whenever the temperature of the PCM exceeds the ambient coolant fluid temperature. Enhanced coolant fluid cooling around the periphery of the PCM confinement structure is possible by providing fins on the outer surface of the PCM chamber walls. For air cooling, powered airflow can be provided during charging (using the external power source for operation of a fan—not shown) and passive airflow can be provided during driving such that cooling fluid—air in this embodiment—is provided for either of battery charging and battery discharging conditions. While air cooling has been described in greater detail herein, it is feasible to use a liquid cooling fluid with a separate heat exchanger located remotely from the battery module. Just as with air cooling, the incremental protections afforded by the PCM are operative in a liquid cooled implementation.

To further improve the operation of the PCM thermal management approach of the invention, it is desirable to provide a PCM that has particularly advantageous performance features. It has been found that providing a PCM having a melting temperature that is below 60° C. will be effective for mitigating most major battery deterioration during charging and discharging conditions, but it has been found more desirable to provide a PCM having a lower melting temperature that is near the upper range of efficient battery operation, roughly between about 30 and 40° C. In one preferred implementation of the invention, a PCM with a melting temperature of 35° C. was found to achieve very desirable results. This desirable melting temperature tends to stabilize battery temperature (for a Lithium ion battery) at a level that is substantially free from battery deterioration during normal operation. In the event that excessive heat is generated, TEGs can be used to generate electricity, providing energy recapture of otherwise wasted heat, and ultimately if there is still too much extra heat generated, the fluid coolant is operative to discharge the excess heat from the vehicle.

To further optimize the performance of the inventive concepts, it has been found desirable to provide a PCM having a Latent Heat Capacity above 150 kJ/kg, and preferably greater than 200 kJ/kg. This provides good energy storage capacity and is compatible with the performance requirements of electric vehicles. Additionally, the PCM should desirably have a Specific Heat Capacity of at least 20 J/gm/Kelvin.

Another consideration in the provision of a suitable PCM is the thermal conductivity within the PCM. In some instances, there can be uneven thermal distribution resulting in either incomplete melting or incomplete solidification at or near the transition temperature. This results in deterioration of the reliability of the thermal management approach. To improve the reliability of the freezing and thawing of the PCM, additives can be provided that improve thermal conductivity within the bulk PCM. Some prior approaches have included use of a PCM filled graphite matrix, copper foam saturated with PCM, and a carbon fiber-PCM composite. Each of these approaches has been reported as providing improvements in thermal conductivity relative to the conductivity of the bulk PCM alone.

An additive might be any one or more of the structures/elements/materials mentioned in the article mentioned above, the purpose being to improve the performance of the PCM in terms of reliably transitioning from one phase to the other in a complete and uniform manner. Of course, considerations such as reliability and cost might lead to adoption of a solution that is commercially valuable even if the technical performance is not the absolute or theoretical highest. The purpose of the additives is to enhance performance relative to the performance without the additive. Some additional additives that can be employed to implement the invention include one or more of nanoparticles, nanosheets, nanofibers, nanotubes, nanowires, nanorods or droplets. These additives can positively influence the specific heat and the thermal conductivity of PCMs. For example, TiO₂ nanoparticles in saturated BaCl₂ solution leads to a linear increase in thermal conductivity with the volume fraction of the nanoparticles.

Another performance feature of some PCMs is their tendency to exhibit supercooling. This is a phenomenon where a material's crystallization initiation occurs only after the material has fallen below the freezing temperature of the material. If supercooling is considerable, it is disadvantageous to efficient battery management because of the deviation from performance expected by the battery control equipment, leading to potentially inefficient starting or stopping (or inappropriate regulation) of current flow through the batteries. It has been found that the introduction of microstructures within the PCM can eliminate or at least reduce the incidence of supercooling. Nanoencapsulation and micromaterial additives can be employed to further limit undesirable supercooling material performance. With respect to nanoencapsulation, the PCM melts inside the capsule while the shell remains solid, with uniform temperature throughout the melting process/phase transition. Encapsulation can be implemented through use of any of urea-formaldehyde resin, melamine-formaldehyde resin, and polyurethanes.

Thermal storage capability depends on thermophysical properties during this phase change process. Upon cooling below the melting point the PCM returns to its initial solid state.

In the operation of the implementation described above, there is a thermal storage characteristic of the PCM that lends itself to generating electricity through use of a TEG. As stated previously, the opportunity to recapture this heat energy provides a system performance improvement relative to systems that discharge all of the excess heat through use of the cooling fluid. Every incremental improvement in vehicle range is desirable in an electric vehicle and this opportunity to recapture otherwise lost heat energy is an incremental benefit of this implementation of the present invention. The stored heat in a PCM has a hysteresis characteristic such that the stored energy can be recaptured through use of a TEG for some time after the heat has been generated by the batteries, allowing efficient energy recapture through the TEGs. As energy is captured by the TEGs, the PCM is cooled, leading to its eventual recrystallization and return to ambient temperatures.

As a desirable example of a PCM that can be used to implement the invention, various fatty acids have been evaluated and found suitable. A suitable fatty acid based eutectic PCM can cover the operating temperature range from 27 to 75° C. and can have latent heat in the range of 168 to 211 kJ/kg. It has been determined that the highest storage density available is in the form of thermochemical phase change materials and thus it is preferred that these materials be employed in implementation of the invention.

The onset solidification temperature observed is well below the onset melting temperature in the heat flow curves of particular eutectics PCMs. The crystallization of the eutectic PCMs is complete during the solidification process. By adopting PCM with these characteristics, a thermal management system can efficiently manage the battery temperature such that the battery surface temperature can be reduced by about 15° C. relative to conventional battery management systems. The generated heat can be effectively transferred inside the PCM module with excellent temperature uniformity. By keeping the PCM layer thickness in the range of 3 to 5 mm, the energy density of the battery pack is not materially lowered relative to battery packs that don't employ the invention. With the cell-to-cell PCM cooling layout, the maximum temperature rise could be <5° C. at 2 C rate. In systems embodying the invention, having heat rejection from the cells to PCM and subsequently to air, the cell temperature uniformity is <0.1 degree C. at 2 C rate. This is achieved by creating a novel PCM having a specific heat capacity of about 25 J/g/K and a latent heat of fusion of about 200 kJ/kg. The desired melting point is about 35° C. The eutectic phase change materials showed exceptional thermal energy storage characteristics up to 75° C. and have proven suitable for thermal management of batteries.

Referring to FIG. 1B, another embodiment of the invention is shown wherein the interstices between twelve individual battery cells are filled with PCM. The dimensions of the battery module are selected so as to contain the 12 tightly-packed cells, set up for instance as 4 rows and 3 columns of cells making up the module. Each cell of the module is specified to have a pre-selected energy storage capacity, 16 Wh each in this example, for a module capacity of 194 Wh. The batteries in the module have a weight of 840 g (70 g per cell) and a volume of about 290 cc (24 cc per cell). The PCM in the module weights about 125 g and has a volume of about 140 cc. The design of the module starts with a determination of the total heat that is typically generated within the battery cells during a rapid charging cycle. Rapid charging could be for instance a substantially full recharge within a time period of less than one hour, and preferably in less than 15 minutes. At high charge rates, the heat generated in the cells poses risks of overheating unless steps are taken to mitigate the temperature rise associated with the heat generation. For the example given, the total heat generated by a fast charge can be roughly calculated as a function of the heat generated by the sum of the heat from electrochemical reactions and the heat from polarization. In the present example, it is assumed, for discussion purposes, that approximately 40,000 joules are provided to the module during a short sample charging operation. The heat generated during this charge cycle can be either calculated or measured (measuring the temperature change of the battery cells). Either way, the objective is to get a determination of the total amount of heat that will be generated during the charging operation. Then, to manage the thermal environment for the battery during charging, a suitable amount of PCM can be provided in thermal communication with the battery. In one preferred embodiment, the PCM's latent heat of fusion is 200 kJ/kg and the mass of the PCM is 125 g. This will greatly assist in avoiding excessive temperature rises within the battery module. By selecting a quantity of PCM that has a cumulative heat absorption capacity that is equal to the amount of heat generated during a charge operation, the temperature of the exterior surfaces of the will be held roughly constant over the full charge cycle. Generally, it will be acceptable to employ a lesser quantity of PCM, such as is sufficient to absorb 75%, or even 50% of the heat generated during a battery charge cycle. When the total heat absorption capacity of the PCM is less that the total heat generated, there will be a temperature rise within the PCM. This can be dissipated through radiation, or direct cooling, such as by circulating a cooling fluid through the PCM.

An improved process for removing heat from the PCM involves providing a cold-plate at the base of the battery tray, and having the PCM is thermal communication with the cold plate. This will allow for removal of heat from the PCM while the PCM is within the desired operating temperature for the battery cells. The cold-plate can be cooled by the cold side of a heat pump, by circulation of a cooled fluid or by circulation of ambient air, in each case the significant consideration being that heat is removed from the PCM while the PCM is below its phase change temperature.

FIGS. 1A-1C illustrate an embodiment of the invention having a three-dimensional array of battery cells, including suitable PCM material with each of the upper tray and the lower tray. It has not previously considered feasible to have a multilevel battery configuration due to the significant heat dissipation requirements associated with charging and discharging the batteries. The provision of PCM in accordance with the embodiment of FIG. 1 permits stacking of battery trays for the purpose of creating a very tight battery configuration, reducing the space required within the vehicle. While not shown in FIG. 1, the battery trays will have a top cover in practice. An additional cold plate could be provided in the top cover. Further, the floor of the upper tray could serve as the lid for the lower tray. Then, the circulating coolant within the tray 21 would cool the cells above and below plate 21.

In another aspect of the invention, it is possible to include more than one PCM material in the overall system. For instance, plate 21 could be filled with a PCM material that has a different melting temperature that the melting temperature of PCM material 60. In a further variation, cold plate 21 might be twice the length of tray 10, and then depending upon ambient temperatures, plate 21 could be slid either to the left or to the right, exposing either a higher melting temperature PCM, or a lower melting temperature PCM to the thermal interface with tray 10. The ability to select a PCM having either a higher or lower melting temperature will permit operation of the vehicle to proceed without complications in varying environmental conditions such as might occur when making a road trip from a very hot to a very cold environment.

Another aspect of the present invention relates to the integration of batteries into battery operated mechanisms. More particularly, the invention is useful in the integration of batteries into electric motor vehicles. The integration of batteries into motor vehicles in accordance with the invention can be optimized through integration of the design of the motor vehicle with battery specifications taken into consideration as an integral part of the vehicle design, and then designing the batteries in a manner so they can be effectively integrated into the motor vehicle. By designing both the vehicle and the batteries with a view to integration of the two together, an improved electric vehicle results.

Previous attempts to integrate batteries into motor vehicles have centered around battery configuration for assembly line integration. There have also been efforts made to design batteries so they would fit into new vehicle designs, resulting in a large number of different shapes and sizes of batteries available in the aftermarket. These batteries need to be selected carefully to be sure the correct battery is being purchased when replacing a worn-out battery. Correct battery selection means selecting a battery that will physically fit into the dedicated battery compartment as well as having the correct battery rating to meet the energy requirements of the vehicle. As electric vehicles have become more common, new attention has been directed to battery design and configuration. Still, specific battery packs have been employed for specific vehicle designs. Fundamentally, these battery packs have still been designed to fit the space originally contemplated for battery placement in the vehicle design. In commonly employed skateboard designs, the vehicle has a panel spanning the underside of the vehicle for providing structural strength. This panel has become the typical installation location for batteries in electric vehicles. Commonly referred to as a tray, or battery tray, a portion of the bottom panel has commonly been dedicated to carrying the battery pack(s) for the electric vehicle. For example, U.S. Pat. No. 10,300,948, issued May 28, 2019 for “Webbing devices for an underbody of a motor vehicle” describes the vehicle structure having this skateboard design. The incorporation of a battery tray along the skateboard floor is disclosed in U.S. Pat. No. 10,949,156 issued Aug. 18, 2020 for “Battery Module Structural Integration”. This has become the standard approach for locating batteries in an electric vehicle. A dedicated floorspace along the skateboard panel is available for the batteries—no more and no less.

Another reality for electric vehicles is that the total energy stored in the battery system is a major design consideration in determining the vehicle's range. Total stored energy is the amount of energy available to power the vehicle along its route. Since it is common for the vehicle to be designed with a given physical space provided for location of the battery system, the next variable is the amount of energy that can be stored within the allocated space. When converting an ice vehicle to a fully electric vehicle, the space available for the drive train is already established—in a manner optimized for the internal combustion drive train. The energy density of the battery system is a measure of the amount of energy that can be stored within a given volume. Thus, the higher the energy density, the greater the potential amount of stored energy and hence, the greater potential range the vehicle will have. Vehicle range is a function of the stored energy and the amount of energy needed to move the vehicle. There are numerous factors in the amount of energy needed to move the vehicle, including aerodynamic design, speed and vehicle weight. Thus, having higher energy density within the battery system, for the given allotted space for the battery system, contributes to vehicle range. To address the energy density consideration, the use of Lithium Ion battery technology has become common. Even with Li-Ion batteries, the interest in gaining energy density persists. Examples of approaches employed to gain the highest possible energy density in Lithium-Ion batteries are discussed in each of U.S. Pat. No. 10,680,213, dated Jun. 9, 2020 for “Compact Secondary Battery Module and Secondary Battery Pack Using Same” and U.S. Pat. No. 10,647,206, issued May 12, 2020 for “Battery Module, Battery Pack Comprising Battery Module, and Vehicle Comprising Battery Pack”.

There is however a safety consideration with Lithium Ion batteries—they generate lots of heat as they are charging (particularly if overcharged) making it imperative that thermal considerations are addressed. Either avoidance of the issue or addressing the issue are necessary. Avoidance of the issue is described to address this concern, for instance in U.S. Pat. No. 10,763,488, issued Sep. 1, 2020, for “Overcharge protection assembly for a battery module”. This patent explains the provision of overcharge technology. Numerous approaches to cooling have also been disclosed, for instance in U.S. Pat. No. 10,749,228, issued Aug. 18, 2020, for “Battery Module, Battery Pack Comprising Battery Module, and Vehicle Comprising Battery Pack” which discloses cooling technology for Li-Ion battery packs. Another attempt to deal with thermal considerations in Li-Ion batteries can be found in U.S. Pat. No. 10,749,226, dated Aug. 18, 2020 for “Battery Module, and Battery Pack and Vehicle Comprising the Same”.

There have also been cooling approaches that rely on circulation of a coolant fluid (gas or liquid) to reduce the tendency of Li-Ion batteries to overheat. Placement of the batteries in the front of the vehicle has been proposed to take advantage of frontal airflow and provision of airflow through the battery tray in a skateboard design has been proposed, but in each case, reliance on airflow is not believed to be adequate, particularly due to the fact that overcharging risk is at its greatest risk when the vehicle is stopped for recharging. The use of liquid cooling has been proposed too. A fixed and dedicated cooling arrangement is provided in the main battery module. For instance, U.S. Pat. No. 10,734,692, issued Aug. 4, 2020 for “Battery coolant loop pad for electric vehicles” discloses an arrangement for circulating coolant through a Lithium Ion battery module to help manage the temperature of the battery packs.

Even with all of the attention that has been given to making Lithium Ion batteries the perfect solution for electric vehicles, there is persistent consumer desire for greater vehicle range, calling for further advances in the implementation of Li-Ion batteries in electric vehicles.

Some factors that interfere with advances are scientific and/or technical in nature while others are based on a lack of seeing the solutions that rely on existing technology. An example of an existing impediment to extending vehicle range is the continued design of electric vehicles using vehicle designs that were originally intended for internal combustion engines. These design considerations include, to a greater or lesser extent, a desire to manufacture every vehicle on a dedicated assembly line having substantially no variation from one vehicle to the next along the assembly line. Further, there is a tendency to duplicate tried and true manufacturing processes that originated in connection with internal combustion engine driven vehicles, even though the old technology is now being used in a manufacturing process for producing electric vehicles.

An example of the tendency to use ICE technology, even for electric vehicles, is the tendency to provide a fixed and inflexible battery tray in electric vehicles. This is a carry-over from ICE design where the battery was typically a lead acid battery of fixed shape and size, even if there was some degree of variation in energy storage capacity of batteries that would fit into the battery box/tray. The battery specifications were inflexible over the entire vehicle range. Vehicles without electrically driven accessories were specified with the same battery compartment as other vehicles in the same vehicle line that were fully loaded with electrically driven accessories. Even though there may have been possibilities of getting a higher capacity battery for the vehicle, it had to fit within the battery compartment that was specified for the vehicle. Thus, while there was some ability to select a battery with a higher energy density, there was no ability to install a physically larger battery. For electric vehicles, there has been widespread following of the pre-existing design approaches that result in battery pack geometry being defined in skateboard models specifying the size and power output of the battery pack and these are constrained by strict specifications provided by the user/Original Equipment Manufacturer (OEM). There may still be the ability to change energy density (wh/L or wh/kg) by adding alternative battery packs, but there has been no option to change the overall pack geometry.

This approach is not optimized for electric vehicles and it has been found that there is no need to continue to follow this old technology path. Accordingly, it is proposed to provide additive power outputs that are not preordained to be limited in individual cell performance, and that are not constrained to the same dimensions as specified by a user/OEM from initial production. As a result, while such previous models limited battery pack performance as a result of the specified battery physical size at the time of initial production (similar to internal combustion engine (ICE) platforms having zero options for performance modifications) allowing only replacement of individualized batteries (or battery packs) for additive performance features relating to the vehicle/product output—but still limited to the physical dimensions of the original battery compartment. Legacy platforms, specifically within the skateboard chassis design, have initial allocated spaces for battery geometries, and they also have limited thermal management capabilities. The limited thermal management capabilities, as with physical size limitations, are also impediments to modifying the battery pack capabilities within a specifically designed vehicle.

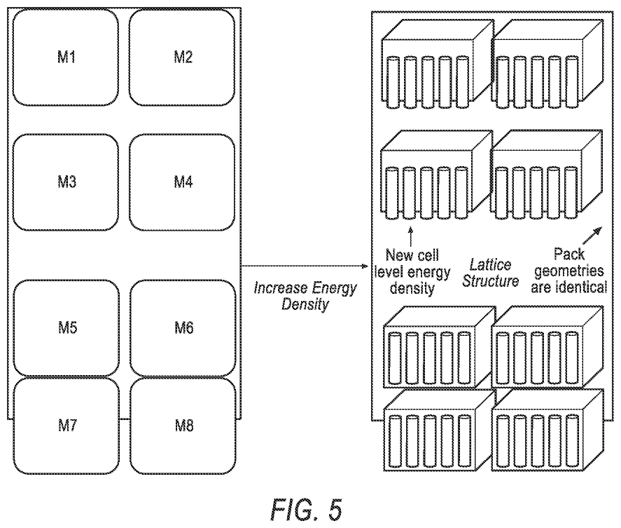

Coolant lines have been adaptable in legacy models based on version/configuration but have been limited to adaptations within the pre-existing pack geometries for specific battery module configurations. The thermal management aspects of the present invention do not rely on module configuration, simply on thermal management adaptability and geometrical limitations due to other vehicle/product constraints (seat brackets, electrical harnesses, motor/inverter configurations, etc.). While the present invention adapts the battery pack and associated cooling hardware to fit between and around such vehicle components as the seat brackets, electrical harnesses and motor/inverter elements, previous battery arrangements based on prior models cannot conform to surrounding geometries based on assembly configuration. Throughout manufacturing lines defined by a user/OEM, workstations for processing sub-assemblies are present, including assembly workstations for assembly of battery pack elements. These previous workstations for handling battery pack sub-assemblies do not have the ability for multi-functional inputs surrounding separate modules. The modules surrounding skateboard OEMs do not traditionally build component-by-component parts for such packs. Traditionally, there are sub-assembly types that are introduced at some point along the manufacturing line defined by user/OEM that implement tier 1 supplier cells, and these components are standardized for the entire vehicle line, without variation for individual vehicles, regardless of the extent of their electrical accessory content and associated power requirements. This legacy model focuses on high volume production and cost-focused production without introducing adaptability across multiple versions for such battery packs that relate back to the customer (depending on configuration at purchase of a vehicle/product). There are numerous reasons for an OEM to desire uniformity in design, some technical, impacting quality, cost and complexity. Such examples of the need for configurability are relevant with current EV OEMs focused on high volume production with limited configurability, specifically on the power train side and energy storage capabilities. Manufacturing architectures defined by such user(s) (the OEMs) have been fundamental into the go-to-market strategies surrounding powertrain and energy storage. Legacy models focus on geometrical equivalent behaviors with greater interior capabilities rather than modifying geometrical functions surrounding energy storage as user/OEMs can hinder themselves relying on other parties/suppliers for improvement of such technologies, resulting in hindering overall production for such version configured via customer. Such legacy models are illustrated in FIG. 5, which shows a prior art battery module having a plurality of battery packs.

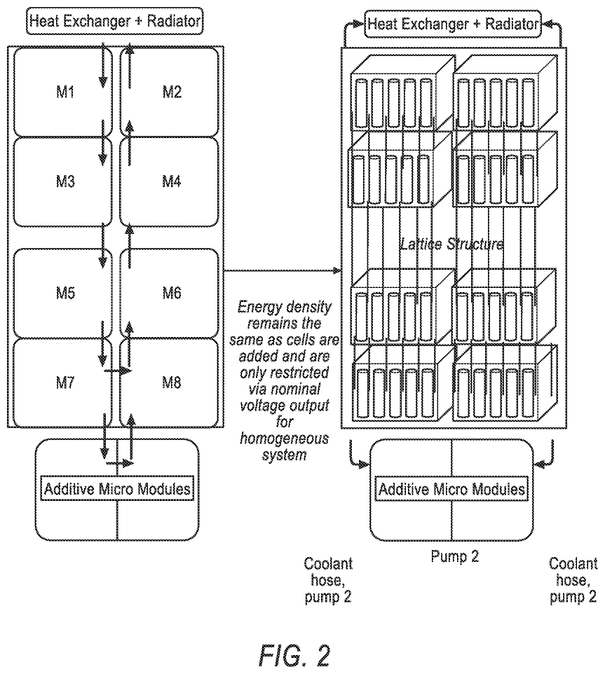

Referring to FIGS. 2-4, a battery module according to other aspects is shown.

Some factors that interfere with advances are scientific and/or technical in nature while others are based on a lack of seeing the solutions that rely on new and non-obvious implementations of existing technology. An example of an existing impediment to extending vehicle range is the continued design of electric vehicles using vehicle designs that were originally intended for internal combustion engines. One of such factors is the design of a finite physical space for a battery pack without first assessing the optimum electrical supply (peak power and total stored energy) for the fully outfitted vehicle with all of its electrical accessories. By pre-determining the physical space available for a battery pack for any given vehicle, the amount of energy that can be stored becomes a direct function of the energy density of the battery storage system. While energy density continues to improve, it is not beneficial for overall vehicle design to eliminate flexibility in the amount of space available for the battery system.

Geometrical adaptability at an accessible rate, in terms of high-scale production, can be attainable for a user/OEM for any desired battery additive/subtractive needs, on a vehicle-to-vehicle basis. General accessibility to this customization flexibility from a manufacturer's standpoint leads to smaller development times relating to excess assembly line versions required for assembly pre-manufacturing and post-manufacturing. This includes thermo-management (cooling manifold/hose capabilities) surrounding the interior of the modules with respect to battery cells (pouch or cylindrical based for passive cooling applications). Cooling within specific modules shouldn't concern the user/OEM in terms of the additive/subtractive methodology as seen in the embodiments of the invention (the MBC) but the connection points with respect to the modules' connectivity and geometry is a concern as to the assembly of the packs (whatever modules are used) as multitudes of module configurations are possibly present within the same pack. The specific configuration with micro/macro module adaptions present within the same pack are what defines the unique components within the MBC model as the micro modules are enabled to be a part of post-manufacturing addition methods based on customer preference that is reported to user/OEM. Such modules preferably have equivalent cooling capabilities to facilitate directly connected thermal capabilities for any additive module configurations across a platform's battery pack within the skateboard chassis model. The improved process and configurations can be seen in FIG. 2.

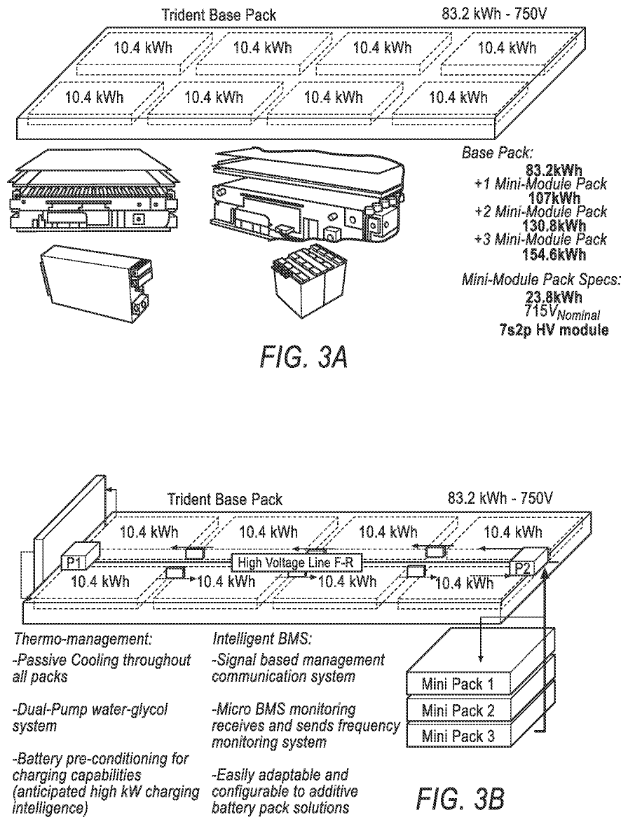

MBC model's additive micro/macro module model can employ the primary tray thermal management capabilities rather than requiring a completely independent system. This enables an OEM/user to focus on cost of internal thermal management within the module rather than expanding focuses to external capabilities regarding independent modules. Having a common cooling system is easier to manage than having multiple cooling systems. Another novel capability of the MBC methodology is the ability to add these micro/macro modules to any part or at substantially any location on the vehicle/product that is not constrained geometrically. Geometric constraints are either directly or indirectly created by the overall vehicle design provided by the user/OEM. Micro-Modules are able to be located pretty much anywhere on the vehicle, and on most any sub-assembly (including front and rear) which enables installation of the micro modules at any available location on a vehicle platform and they can be tailored from vehicle to vehicle based on total electrical demands and can be further tailored across multitudes of platforms. This is illustrated in FIGS. 3A-3B.

Processes during chassis assembly are provided for integration of additive packs (equal nominal voltages are preferred for wiring purposes based on OEM configuration) with different capacities. Battery Module Sub-assemblies are designed for integration of certain modules/packs based on the total kWh capacity (amount of modules/packs) that the customer requests. Manufacturing processes will be equivalent whether introduction of additive packs occurs pre-production release or post-production release to customer of the vehicle. This selection as to when the additive packs are added is dependent upon overall vehicle assembly requirements, considering vehicle and accessory geometries, the overall system heating and cooling systems and other hard-wiring capabilities. The heating and cooling functions may benefit from insulation imbedded in specific components (rocker panel, side rail, etc.) defined by user/OEM. The battery packs can be structured dimensionally to fit within space left open by a user/OEM in the ordinary vehicle design process (or chassis design process). There are multitudes of locations where it is possible to include such packs during the assembly process including but not limited to: interior portion running alongside rails of front/rear sub assembly “drive unit assemblies”, above a center-tub standard battery pack (modifications to top/bottom panel may be implemented for safety concerns and proper insulation surrounding each module and circulation of coolant for thermal capabilities), above rails bracing front/rear drive units' assemblies with center tub. The manufacturing processed for installing the battery packs at these locations are set at the pre-production ready level rather than requiring modifications for post-production when extra battery capacity is needed to meet a customer preference. Pre-assembly measures can be arranged from original source (including base model pack configurations ordered by user/OEM and defined by customer) which includes potential hosing lines and inclusions built into sub-assembly platforms or center tub, additional supportive brackets may be required based on weight (number of additive packs integrated) added to an area defined by user/OEM.

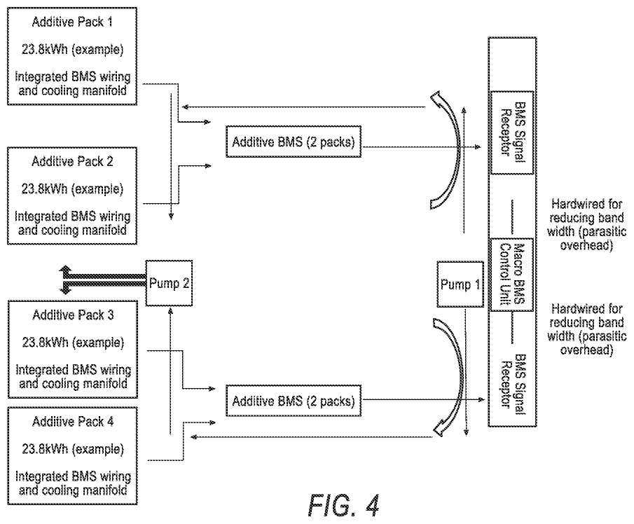

Thermo-management and battery management are clear inclusions in the MBC methodology (as it is necessary) but are integrated in an efficient matter related to additive packs/modules incorporating the same cooling methods as are provided for the base battery pack. Additive packs receive the coolant through equivalent methods as center-tub “main pack” cells and are connected via secondary hoses added either during production or post-production according to customer preferences. All wiring components (Battery Management System (BMS) signal/COM) are incorporated within the integration process, whether that includes hard wiring or microchip signal/frequency communication from additive packs to control unit, location defined by user/OEM. By equalizing the thermo-management across the additive modules to center tray/pack, user maintains equivalent entropy levels for reduced heat transfer loss (generally due to internal resistance of the cells) and based on heat content ratios (dependent on the size and number of additive modules) enthalpy can be equated as well. This enables greater performance across pre/post-production additive methods without compromising degradation rates of equivalent cells. Charge rates will be maintained (not compromised with additive packs/modules) due to equivalent pump rates for integrated water-glycol solution introduced within the center tray/pack. Another solution available using the MBC method is the introduction of hydrogels within additive packs as well for managing expansion and contraction at the cell level based on the charging kilowattage that a customer chooses. This equates to longer cell-level life, decreasing degradation (often acts as an exponential effect as a defect in one cell within a series system compounds the rest of a module). Such polymer structures enable the user/OEM to have multitudes of configurations with the additive packs as thermo-management methods preferably are equivalent from cell to cell for coolant pump purposes when maximizing flow rates within the passive manifold, surrounding transfer methods (condensers, hydrogels, immersive oils) do not impact overall power output/performance assuming all cells degrade at the same rate. One desired design feature of the MBC method is to provide equivalent manifold connecting cooling lines (not manifold) for overall thermo-management system software capabilities. Vehicle systems for coolant pump recognition should be homogeneous across all/any additive packs for continuous and expecting mass flow rate calculations occurring at a vehicle control unit attached to north portion of center battery pack (see FIG. 4). This control unit includes a macro battery management system (interprets signals gained from center tray modules as well as any other additive signals) and connects all portions of thermo-management to the electronic control unit (ECU) associated with battery systems. This reduces bandwidth for on-board data management, ultimately reducing parasitic overhead with respect to assuming normal conditions. Such signals included in the MBC model are simulated in FIG. 4.

Accordingly, pursuant to an aspect of the disclosure, there is provided a battery arrangement comprising a base battery module having a first storage capacity installed in an electric vehicle at a battery tray location and having at least one additional battery module having a second storage capacity lower than said first storage capacity installed in said motor vehicle at a location separate from the battery tray location.

Pursuant to an implementation, the base battery module is cooled by a primary battery cooling system, and wherein said additional battery module is cooled by said primary battery cooling system through an interconnection comprising at least one supply cooling tube.

Pursuant to an implementation, the base battery module and/or the at least one additional battery module includes a tray with a plurality of battery cells disposed in an interior of the tray, and wherein a phase-change material (PCM) is disposed in the interior of the tray in thermal communication with at least one of the battery cells. The PCM may at least partially surround the at least one battery cell. Optionally, the PCM fully surrounds the at least one battery cell, at least in the circumferential direction of the respective battery cell.

Pursuant to an implementation, a thermoelectric generator may be provided in thermal communication with the PCM in a region of the at least one battery cell.

Pursuant to an implementation, a cooling plate may be disposed at a bottom of the tray. The phase-change material may thermally contact the cooling plate and the at least one battery cell. The cooling plate may have one or more channels for conducting a cooling fluid/medium.

While the invention has been described with respect to several specific implementations, it is to be understood that the innovation includes many other possible implementations based on the inventive concepts as described herein.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that a computer, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

An electronic controller and/or an electronic processor may include a programmable microprocessor and/or microcontroller, such as an application specific integrated circuit (ASIC). The controller may include or communicate with a memory (e.g., a non-transitory computer-readable storage medium, and/or an input/output (I/O) interface. The controller may be configured to perform various functions, including those described in greater detail herein, with appropriate programming instructions and/or code embodied in software, hardware, and/or other medium.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A manufacturing method for integrating electrical storage battery capacity requirements into the vehicle design process and providing for the customization of battery capacity on a vehicle by vehicle basis during the manufacture of the vehicle.

2. A battery arrangement, comprising:
a base battery module having a first storage capacity installed in an electric vehicle at a battery tray location and having at least one additional battery module having a second storage capacity lower than said first storage capacity installed in said motor vehicle at a location separate from the battery tray location.

3. The battery arrangement of claim 2, wherein the base battery module is cooled by a primary battery cooling system, and wherein said additional battery module is cooled by said primary battery cooling system through an interconnection comprising at least one supply cooling tube.

4. The battery arrangement of claim 2, wherein the base battery module includes a tray with a plurality of battery cells disposed in an interior of the tray, and wherein a phase-change material (PCM) is disposed in the interior of the tray in thermal communication with at least one of the battery cells.

5. The battery arrangement of claim 4, wherein the PCM at least partially surrounds the at least one battery cell.

6. The battery arrangement of claim 4, further comprising a thermoelectric generator in thermal communication with the PCM in a region of the at least one battery cell.

7. The battery arrangement of claim 4, further comprising a cooling plate disposed at a bottom of the tray, and wherein the phase-change material thermally contacts the cooling plate and the at least one battery cell.

8. The battery arrangement of claim 2, wherein the at least one additional battery module includes a tray with a plurality of battery cells disposed in an interior of the tray, and wherein a phase-change material (PCM) is disposed in the interior of the tray in thermal communication with at least one of the battery cells.
